(19) United States
(12) Patent Application Publication
(10) Pub. No.: US 2009/0028771 A1
(43) Pub. Date: Jan. 29, 2009

(54) METHOD FOR MANUFACTURING LITHIUM-IRON-PHOSPHORUS COMPOUND OXIDE CARBON COMPLEX AND METHOD FOR MANUFACTURING COPRECIPITATE CONTAINING LITHIUM, IRON, AND PHOSPHORUS

(75) Inventors: Yasuhiro NAKAOKA, Tokyo (JP); Tadayoshi YANAGIHARA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON CHEMICAL INDUSTRIAL CO., LTD., Tokyo (JP)

(21) Appl. No.: 12/179,080

(22) Filed: Jul. 24, 2008

(30) Foreign Application Priority Data
Jul. 24, 2007 (JP) 2007-192698
Jul. 14, 2008 (JP) 2008-182663

(51) Int. Cl. C01B 25/45

(52) U.S. Cl. 423/306

(57) ABSTRACT

A method for manufacturing a lithium-iron-phosphorus compound oxide carbon complex includes the steps of adding a solution containing lithium ions (Solution B) to a solution containing phosphate ions (Solution C) while a solution containing divalent iron ions (Solution A) is added to Solution C so as to produce a coprecipitate containing lithium, iron, and phosphorus in a first step, mixing the coprecipitate and an electrically conductive carbon material so as to produce a raw material mixture for calcining in a second step, and calcining the raw material mixture for calcining in an inert gas atmosphere so as to produce the lithium-iron-phosphorus compound oxide carbon complex in a third step.

### BACKGROUND OF THE INVENTION

1. Field of the Invention

The present invention relates to a method for manufacturing a lithium-iron-phosphorus compound oxide carbon complex useful as a lithium secondary battery positive electrode active material.

2. Description of the Related Art

In recent years, along with rapid progress in household electric appliances toward portable and cordless, lithium ion secondary batteries have become commercially available as power sources for compact electronic devices, e.g., lap top personal computers, cellular phones, and video cameras. Regarding the lithium ion secondary batteries, since Mizushima et al. reported the usefulness of lithium cobaltate as a positive electrode active material for the lithium ion secondary batteries in 1980 (“Material Research Bulletin”, vol 15, p. 783-789 (1980)), active research and development have been made on lithium cobaltate, resulting in many proposals until now.

However, Co is unevenly distributed in the Earth and is a rare resource. Therefore, for example, new positive electrode active materials, e.g., LiNiO₂, LiMn₂O₄, LiFeO₂, and LiFePO₄, serving as alternatives to lithium cobaltate have been developed.

Regarding LiFePO₄, the volume density is a large 3.6 g/cm³, a high potential of 3.4 V is generated, and the theoretical capacity is also a large 170 mAH/g. Furthermore, LiFePO₄ includes one Li atom per Fe atom in an initial state, and the Li atom can be desorbed electrochemically. Therefore, LiFePO₄ is highly expected to become a new positive electrode active material for the lithium secondary battery, serving as an alternative to lithium cobaltate.

As for the method for manufacturing LiFePO₄, a production method by using a solid phase process has been proposed. However, a homogeneous mixture, in which individual raw materials are precisely mixed, is required for producing a single phase of LiFePO₄ on an X-ray diffraction analysis basis. Consequently, it is difficult to industrially obtain a product having stable quality.

As for the method for producing a homogeneous mixture of individual raw materials easily, various proposals by using a coprecipitation method have been made. For example, a method by using a coprecipitate obtained by adding a solution containing lithium hydroxide to a solution containing lithium dihydrogen phosphate and iron sulfate is proposed in page 5 of PCT Japanese Translation Patent Publication No. 2004-525059. A method by using a coprecipitate obtained by adding lithium carbonate or lithium hydroxide to a solution containing metal iron and a compound which liberates a phosphate ion in the solution is proposed in page 1 of International Patent Publication WO 2004/036671. Furthermore, a method by using a coprecipitate of compound phosphate of lithium and iron is proposed in page 1 of Japanese Unexamined Patent Application Publication No. 2002-117831, wherein the compound phosphate is obtained by mixing a phosphate aqueous solution containing a lithium salt, an iron salt, and a water-soluble reducing agent with an alkaline solution.

However, these methods by using the coprecipitation method have problems in that it is difficult to adjust the composition of Li, Fe, and P and it is difficult to obtain a single phase of LiFePO₄ on an X-ray diffraction analysis basis.

### SUMMARY OF THE INVENTION

Accordingly, it is an object of the present invention to provide a method for manufacturing a lithium-iron-phosphorus compound oxide carbon complex suitable for adjusting the composition of Li, Fe, and P of a lithium-iron-phosphorus compound oxide in the lithium-iron-phosphorus compound oxide carbon complex easily, obtaining a single phase of LiFePO₄ on an X-ray diffraction analysis basis, and imparting excellent battery performance to a lithium secondary battery.

The present inventors conducted intensive research under the above-described circumstances and obtained the following findings. That is, the composition of Li, Fe, and P in a coprecipitate containing lithium, iron, and phosphorus is adjusted easily by adding a solution containing lithium ions (Solution B) to a solution containing phosphate ions (Solution C) while a solution containing divalent iron ions (Solution A) is added and conducting a reaction. Therefore, the composition of Li, Fe, and P in the lithium-iron-phosphorus compound oxide carbon complex is adjusted easily and the coprecipitate is produced at a high yield. A mixture of the thus produced coprecipitate and an electrically conductive carbon material is fired in an inert gas atmosphere and, thereby, a lithium-iron-phosphorus compound oxide carbon complex is produced in which lithium-iron-phosphorus compound oxide particles composed of a single phase of LiFePO₄ on the basis of the X-ray diffraction analysis and the electrically conductive carbon material are homogeneously dispersed. Furthermore, a lithium secondary battery including the thus produced lithium-iron-phosphorus compound oxide carbon complex as a positive electrode active material has excellent battery performance. Consequently, the present invention has been completed.

According to an aspect of the present invention, a method for manufacturing a lithium-iron-phosphorus compound oxide carbon complex is provided, the method including the steps of adding a solution containing lithium ions (Solution B) to a solution containing phosphate ions (Solution C) while a solution containing divalent iron ions (Solution A) is added to Solution C so as to produce a coprecipitate containing lithium, iron, and phosphorus in a first step, mixing the coprecipitate and an electrically conductive carbon material so as to produce a raw material mixture for calcining in a second step, and calcining the raw material mixture for calcining in an inert gas atmosphere so as to produce the lithium-iron-phosphorus compound oxide carbon complex in a third step.

According to an aspect of the present invention, the composition of Li, Fe, and P in the coprecipitate is adjusted easily. Therefore, a method for manufacturing a lithium-iron-phosphorus compound oxide carbon complex can be provided, wherein a coprecipitate which contains lithium, iron, and phosphorus and which has a uniform composition ratio and stable quality is produced at a high yield, the composition of Li, Fe, and P of the lithium-iron-phosphorus compound oxide in the lithium-iron-phosphorus compound oxide carbon complex is adjusted easily, a single phase of LiFePO₄ on an X-ray diffraction analysis basis is obtained, and excellent battery performance can be imparted to a lithium secondary battery.

### BRIEF DESCRIPTION OF THE DRAWINGS

FIG. 1 is an X-ray diffraction pattern of a lithium-iron-phosphorus compound oxide carbon complex obtained in Example 1.

FIG. 2 is an X-ray diffraction pattern of a lithium-iron-phosphorus compound oxide carbon complex obtained in Comparative example 1.

### DESCRIPTION OF THE PREFERRED EMBODIMENTS

A method for manufacturing a lithium-iron-phosphorus compound oxide carbon complex according to an aspect of the present invention (hereafter may be referred to as a manufacturing method of the present invention) includes the steps of adding a solution containing lithium ions (Solution B) to a solution containing phosphate ions (Solution C) while a solution containing divalent iron ions (Solution A) is added to Solution C so as to produce a coprecipitate containing lithium, iron, and phosphorus in a first step, mixing the coprecipitate and an electrically conductive carbon material so as to produce a raw material mixture for calcining in a second step, and calcining the raw material mixture for calcining in an inert gas atmosphere so as to produce the lithium-iron-phosphorus compound oxide carbon complex in a third step.

The first step according to an aspect of the present invention is a step for producing a coprecipitate containing lithium, iron, and phosphorus (hereafter abbreviated as a “precipitate”) by adding Solution B to Solution C while Solution A is added to Solution C so as to conduct a reaction.

Solution A related to the first step is an aqueous solution containing divalent iron ions and is prepared by dissolving a divalent iron source related to Solution A into water. The divalent iron source related to Solution A is not specifically limited insofar as the divalent iron source is a compound having a divalent iron ion and being soluble into water. Examples thereof include iron (II) sulfate, iron (II) acetate, iron (II) oxalate, iron (II) chloride, and iron (II) nitrate. Among them, iron (II) sulfate is preferable because of a low price. These divalent iron sources related to Solution A may be used alone or in combination.

The content of divalent iron ion in Solution A is preferably 0.1 to 1.5 mol/L in terms of divalent iron atom, and particularly preferably 0.5 to 1.0 mol/L. If the content of divalent iron ion in Solution A is within the above-described range, in the preparation of Solution A, the dissolution rate of the divalent iron source into the solution does not become too low. Therefore, an industrial efficiency is high and the amount of waste solution can be reduced.

Solution B related to the first step is a solution containing lithium ions and is prepared by dissolving a lithium source related to Solution B into water. The lithium source related to Solution B is not specifically limited insofar as the lithium source is a compound having a lithium ion and being soluble into water and, preferably, the resulting solution is alkaline. Examples thereof include lithium carbonate and lithium hydroxide. Among them, lithium hydroxide is preferable from the viewpoint of the capability to increase the pH of the solution while supplying lithium. The content of lithium ion in Solution B is preferably 0.1 to 4 mol/L in terms of Li atom, and particularly preferably 1 to 4 mol/L. If the content of lithium ion in Solution B is within the above-described range, the amount of reaction solution does not increase excessively and dissolution of the lithium source into the solution does not take time excessively, so that the productivity is good. On the other hand, if the content of lithium ion in Solution B is less than the above-described range, the amount of reaction solution increases excessively and, thereby, the productivity tends to become poor. If the content exceeds the above-described range, dissolution of the lithium source into the solution takes time excessively, so that the productivity tends to become poor.

Solution C related to the first step is a solution containing phosphate ions and is prepared by dissolving a phosphate source related to Solution C into water.

The phosphate source related to Solution C is not specifically limited insofar as the phosphate source is a compound having a phosphate ion and being soluble into water. Examples thereof include phosphoric acid, ammonium dihydrogen phosphate, sodium hydrogenphosphate, and metaphosphoric acid. Among them, phosphoric acid is preferable because of a low price. These phosphate sources related to Solution C may be used alone or in combination. In the present invention, the phosphate ion related to Solution C is a generic name for phosphate ions, e.g., orthophosphate ions, metaphosphate ions, pyrophosphate ions, triphosphate ions, and tetraphosphate ions.

The content of phosphate ion in Solution C is preferably 0.1 to 3 mol/L in terms of phosphorus atom, and particularly preferably 1 to 3 mol/L. If the content of phosphate ion in Solution C is within the above-described range, in the preparation of Solution C, the dissolution rate of the phosphate source into the solution does not become too low. Therefore, the productivity is good.

The divalent iron source used for preparation of Solution A, the lithium source used for preparation of Solution B, and the phosphate source used for preparation of Solution C may be hydrates or anhydrides. Furthermore, it is preferable that the impurity content is low in order to obtain a high purity lithium-iron-phosphorus compound oxide carbon complex.

In the first step, Solution C is agitated and Solution B is added to Solution C while Solution A is added to Solution C. In the present invention, the phrase “Solution B is added to Solution C while Solution A is added to Solution C” refers to that the addition time of Solution A to Solution C and the addition time of Solution B to Solution C are equal or overlapped. It is preferable that the addition time of Solution A to Solution C and the addition time of Solution B to Solution C are equal, that is, the start of addition of Solution A and the start of addition of Solution B are at the same time and the termination of addition of Solution A and the termination of addition of Solution B are at the same time, because the composition of Li, Fe, and P in the coprecipitate is adjusted easily. However, the two may not be equal within the bounds of not impairing the effect of the present invention significantly. It is favorable that Solution B is added for at least a period of time during addition of Solution A.

The amount of addition of Solution A to Solution C is specified in such a way that the ratio (Fe/P) of the number of moles of divalent iron atom in Solution A to the number of moles of phosphorus atom in Solution C becomes preferably 0.8 to 1.2, particularly preferably 0.95 to 1.05. On the other hand, preferably, the amount of addition of Solution B to Solution C is specified in such a way that the ratio (Li/P) of the number of moles of lithium atom in Solution B to the number of moles of phosphorus atom in Solution C becomes 1 to 3. In the case where the amount of addition of Solution A to Solution C and the amount of addition of Solution B to Solution C are within the above-described ranges, the composition of the coprecipitate is controlled easily.

The temperature of the reaction solution (Solution C) when Solution A and Solution B are added to Solution C is 10° C. to 100° C. In the case where the temperature of the reaction solution (Solution C) when Solution A and Solution B are added to Solution C is within the above-described range, a lithium component in the reaction solution (Solution C) precipitates easily. If the temperature of the reaction solution (Solution C) when Solution A and Solution B are added to Solution C is lower than the above-described range, precipitation of the lithium component in the reaction solution tends to become difficult. If the temperature exceeds the above-described range, the solution boils at normal pressure and, thereby, a liquid phase reaction becomes difficult.

The addition rates of Solution A and Solution B to Solution C are not specifically limited. Preferably, the addition rates are controlled in such a way that the ratio (Fe/Li) of iron atoms to lithium atoms in the solution during addition becomes 1 or less because stable quality is obtained.

In the first step, after the addition of Solution A and Solution B are completed, aging may be conducted successively, wherein agitation is continued while the temperature of the reaction solution (Solution C) is maintained. By conducting this aging, unreacted element components in the reaction solution phase can be reduced. The aging temperature during aging is 10° C. to 100° C., preferably 30° C. to 100° C. In the case where the aging temperature is within the above-described range, an effect of reducing unreacted components in the reaction solution phase is exerted easily. On the other hand, if the aging temperature is lower than the above-described range, the effect of reducing unreacted components in the reaction solution phase tends to be reduced. If the aging temperature exceeds the above-described range, the solution boils at normal pressure easily and, thereby, an aging reaction tends to become difficult.

In the first step, regarding the addition of Solution A and Solution B to Solution C, the addition of Solution A and Solution B may be conducted while an inert gas, e.g., nitrogen gas, is injected into the reaction solution (Solution C). Furthermore, in the first step, the addition of Solution A and Solution B may be conducted in the coexistence of a reducing agent, e.g., ascorbic acid, phenol, pyrogallol, preferably ascorbic acid in Solution A (solution containing divalent iron ions). In the addition of Solution A and Solution B, oxidation of iron present in the reaction solution (Solution C) can be prevented by injection of the inert gas into the reaction solution (Solution C), coexistence of the reducing agent in Solution A (solution containing divalent iron ions), or both of them. The amount of addition of a reducing agent to Solution A is specified in such a way that the ratio (a reducing agent/Fe) of the number of moles of a reducing agent to the number of moles of divalent iron atom in Solution A becomes 0.1 to 2.0, particularity preferably 0.5 to 1.5. Therefore, the reactivity is good.

In the first step, after the addition of Solution A and Solution B is completed, solid liquid separation is conducted by a common method, the resulting solid matter is recovered and, if necessary, water washing and drying are conducted, so that a coprecipitate is produced. Preferably, the drying temperature during the drying of the coprecipitate is 35° C. to 60° C. because the drying efficiency is good and the divalent iron component is difficult to oxidize. On the other hand, if the drying temperature of the coprecipitate is lower than 35° C., the drying takes time excessively. If the drying temperature exceeds 60° C., the divalent iron becomes easy to oxidize.

The second step according to an aspect of the present invention is a step for obtaining a raw material mixture for calcining by mixing the coprecipitate produced in the first step and an electrically conductive carbon material.

Examples of electrically conductive carbon materials related to the second step include graphite, such as natural graphite, e.g., flaky graphite, scaly graphite, and earthy graphite, and artificial graphite; carbon black and the like, e.g., carbon black, acetylene black, Ketjenblack, channel black, furnace black, lamp black, and thermal black; and carbon fibers. Examples of electrically conductive carbon materials related to the second step also include organic carbon compounds from which carbon precipitates by the calcining in the third step. The electrically conductive carbon materials may be used alone or in combination. Among them, carbon black and Ketjenblack are preferable because fine particles thereof are easily industrially available.

The average particle diameter of the electrically conductive carbon material is 1 μm or less, preferably 0.1 μm or less, and particularly preferably 0.01 to 0.1 μm. In the case where the electrically conductive carbon material is fibrous, the average particle diameter indicates a fiber diameter. In the case where the average particle diameter of the electrically conductive carbon material is within the above-described range, the electrically conductive carbon material comes into the state of being highly dispersed into the lithium-iron-phosphorus compound oxide easily. In the present invention, the average particle diameter of the electrically conductive carbon material is an average particle diameter determined on the basis of a scanning electron micrograph (SEM) and is an average value of particle diameters of 20 particles arbitrarily extracted from the scanning electron micrograph.

The amount of C atoms contained in the electrically conductive carbon material after calcining tends to become slightly reduced as compared with that before the calcining. Therefore, in the second step, if the amount of blend of the electrically conductive carbon material relative to 100 parts by mass of coprecipitate is 2 to 15 parts by mass, and preferably 5 to 10 parts by mass, the amount of blend of electrically conductive carbon material relative to 100 parts by mass of lithium-iron-phosphorus compound oxide in the lithium-iron-phosphorus compound oxide carbon complex easily becomes 1 to 12 parts by mass in terms of C atom, and preferably 3 to 8 parts by mass. If the amount of blend of the electrically conductive carbon material relative to 100 parts by mass of coprecipitate is within the above-described range, in the case where the lithium-iron-phosphorus compound oxide carbon complex is used as a positive electrode active material of a lithium secondary battery, satisfactory electrical conductivity can be imparted. Therefore, the internal resistance of the lithium secondary battery can be reduced and a discharge capacity per mass or volume increases. On the other hand, if the amount of blend of the electrically conductive carbon material relative to 100 parts by mass of coprecipitate is less than the above-described range, in the case where the lithium-iron-phosphorus compound oxide carbon complex is used as a positive electrode active material of a lithium secondary battery, satisfactory electrical conductivity cannot be imparted. Therefore, the internal resistance of the lithium secondary battery increases easily. If the amount of blend exceeds the above-described range, a discharge capacity per mass or volume is reduced easily.

In the second step, preferably, the coprecipitate and the electrically conductive carbon material are dry mixed sufficiently in such a way as to be homogeneously mixed. In the second step, a device or the like used for mixing the coprecipitate and the electrically conductive carbon material is not specifically limited insofar as a homogeneous raw material mixture for calcining is obtained. Examples of devices include a high speed mixer, a super mixer, a turbo sphere mixer, a Henschel mixer, a Nauta mixer, and a ribbon blender. The homogeneous mixing operation of the coprecipitate and the electrically conductive carbon material is not limited to the mechanical means exemplified.

The third step is a step for producing the lithium-iron-phosphorus compound oxide carbon complex by calcining the raw material mixture for calcining obtained in the second step in an inert gas atmosphere.

In the third step, in order to prevent oxidation of a Fe element, the raw material mixture for calcining is fired in an atmosphere of an inert gas, e.g., nitrogen or argon.

In the third step, the calcining temperature in the calcining of the raw material mixture for calcining is 500° C. to 800° C., and preferably 550° C. to 750° C. In the case where the calcining temperature of the raw material mixture for calcining is within the above-described range, the crystallinity of LiFePO₄ increases, so that the discharge capacity increases. In addition, growth of particle diameter is difficult to progress, so that the discharge capacity increases. On the other hand, if the calcining temperature of the raw material mixture for calcining is lower than the above-described range, the crystallinity of LiFePO₄ is low, so that the discharge capacity is reduced easily. If the calcining temperature exceeds the above-described range, growth of particle diameter progresses, so that the discharge capacity tends to be reduced. The calcining time of the raw material mixture for calcining is 1 hour or more, and preferably 2 to 10 hours. In the third step, if desired, calcining may be conducted at least two times. Furthermore, for the purpose of ensuring uniform powder characteristics, the mixture fired once may be pulverized and fired again.

In the third step, after the raw material mixture for calcining is fired, the resulting fired product is cooled appropriately and, if necessary, pulverized or sized, so that a lithium-iron-phosphorus compound oxide carbon complex is produced. It is preferable that the cooling of the fired product is conducted in an inert gas atmosphere in order to prevent oxidation of the Fe element. Regarding the pulverization, which is conducted as necessary, of the fired product, in the case where, for example, the lithium-iron-phosphorus compound oxide carbon complex resulting from calcining is brittle and in the shape of blocks, the fired product is pulverized appropriately.

In the lithium-iron-phosphorus compound oxide carbon complex produced by executing the method for manufacturing a lithium-iron-phosphorus compound oxide carbon complex according to an aspect of the present invention (hereafter may be referred to as the manufacturing method of the present invention), LiFePO₄ particles and fine electrically conductive carbon material are dispersed homogeneously. The lithium-iron-phosphorus compound oxide in the lithium-iron-phosphorus compound oxide carbon complex produced by executing the manufacturing method of the present invention is a single phase of LiFePO₄ on an X-ray diffraction analysis basis. The lithium-iron-phosphorus compound oxide carbon complex according to the present invention is a homogeneous mixture of lithium-iron-phosphorus compound oxide particles and fine electrically conductive carbon material, wherein the lithium-iron-phosphorus compound oxide particles and the electrically conductive carbon material can be visually distinguished by scanning electron microscope observation, and the average particle diameter of the lithium-iron-phosphorus compound oxide particles themselves determined on the basis of a scanning electron micrograph (SEM) is 0.05 to 1 μm, and preferably 0.1 to 0.5 μm. This average particle diameter is an average value of particle diameters of 20 lithium-iron-phosphorus compound oxide particles arbitrarily extracted from the scanning electron micrograph.

According to the manufacturing method of the present invention, the composition of the lithium-iron-phosphorus compound oxide in the lithium-iron-phosphorus compound oxide carbon complex is adjusted easily.

The lithium-iron-phosphorus compound oxide carbon complex produced by executing the manufacturing method of the present invention is favorably used as a positive electrode active material of a lithium secondary battery including a positive electrode, a negative electrode, a separator, and a nonaqueous electrolyte containing a lithium salt. Since the lithium-iron-phosphorus compound oxide carbon complex exhibits hygroscopicity, in the case where the water content is 2,000 ppm or more, it is desirable that an operation, e.g., vacuum drying, is conducted so as to reduce the water content of the lithium-iron-phosphorus compound oxide to 2,000 ppm or less, and preferably 1,500 ppm or less before the lithium-iron-phosphorus compound oxide is used as the positive electrode active material.

In the case where the lithium-iron-phosphorus compound oxide produced by executing the manufacturing method of the present invention is used in combination with known other lithium-transition metal composite oxides, the safety of the lithium secondary batteries by using the known lithium-transition metal composite oxides can be further improved. Examples of lithium-transition metal composite oxides which can be used in combination with the lithium-iron-phosphorus compound oxide carbon complex produced by executing the manufacturing method of the present invention include lithium-transition metal composite oxides represented by the following general formula (1):

LiₐM_{1-b}A_{b}O_{c} (1)

(in the formula, M represents at least one type of transition metal element selected from Co and Ni, A represents at least one type of metal element selected from Mg, Al, Mn, Ti, Zr, Fe, Cu, Zn, Sn, and In, and a, b, and c satisfy 0.9≦a≦1.1, 0≦b≦0.5, and 1.8≦c≦2.2, respectively). Examples of types of lithium-transition metal composite oxides represented by the above-described general formula (1) include LiCoO₂, LiNiO₂, LiNi_{0.8}Co_{0.2}O₂, LiNi_{0.8}Co_{0.1}Mn0.1O₂, and LiNi_{0.4}Co_{0.3}Mn0.3O₂. These lithium-transition metal composite oxides may be used alone or in combination. The physical properties and the like of the lithium-transition metal composite oxides used in combination with the lithium-iron-phosphorus compound oxide carbon complex produced by executing the manufacturing method of the present invention are not specifically limited. However, the average particle diameter is preferably 1 to 20 μm, particularly preferably 1 to 15 μm, and further preferably 2 to 10 μm. The BET specific surface area is preferably 0.1 to 2.0 m²/g, particularly preferably 0.2 to 1.5 m²/g, and further preferably 0.3 to 1.0 m²/g.

### EXAMPLE

The present invention will be described below in detail with reference to the example. However, the present invention is not limited to the example.

### Example 1

### First Step

### Preparation of Solution A

Solution A1 was prepared by dissolving 83.4 g (0.3 mol, in terms of divalent Fe atom 0.3 mol) of ferrous sulfate heptahydrate into 217 ml of pure water.

### Preparation of Solution B

Solution B1 was prepared by dissolving 37.8 g (0.9 mol, in terms of Li atom 0.9 mol) of lithium hydroxide monohydrate into 412 ml of pure water.

### Preparation of Solution C

Solution C1 was prepared by putting 161 ml of pure water and 39.2 g (0.3 mol, in terms of P atom 0.3 mol) of 75 percent by weight phosphoric acid into a reaction container.

### Addition of Solution A and Solution B to Solution C

Addition of Solution A and Solution B to the reaction container (Solution C) were started at the same time under agitation. Addition was continued at a constant rate, and the whole amount was dropped over 42 minutes. After the dropping was completed, solid liquid separation was conducted by a common method, and drying was conducted at 50° C. for 10 hours so as to produce 60 g of precipitate.

The resulting coprecipitate was subjected to an XRD measurement and an ICP measurement. As a result, the resulting precipitate was a coprecipitate of ferrous phosphate octahydrate and lithium phosphate containing lithium, iron, and phosphorus at a molar ratio of 0.8:0.9:1.

The composition of each solution was as described below.

Solution A1: divalent Fe atom 1 mol/L

Solution B1: Li atom 2 mol/L

Solution C1: P atom 1.5 mol/L

### Second Step

A homogeneous mixture was produced by sufficiently mixing 10 g of the resulting coprecipitate and 0.8 g of carbon black (average particle diameter 0.05 μm) with a mixer.

### Third Step

The resulting homogeneous mixture was fired at 600° C. for 5 hours in a nitrogen atmosphere. Subsequently, cooling was conducted in the nitrogen atmosphere as it was, so as to produce a lithium-iron-phosphorus compound oxide carbon complex.

### Example 2

First step

### Preparation of Solution A

3 g of L-ascrobic acid was dissolved in Solution A1 of Example, thereby, Solution A2 was prepared.

### Preparation of Solution B and Solution C

Solution B1 and Solution C1 were prepared in as Example 1.

The addition of Solution A and Solution B to Solution C

A reaction was conducted as in Example 1 so as to produce 60 g of precipitate.

The resulting coprecipitate was subjected to an XRD measurement and an ICP measurement. As a result, the resulting precipitate was a coprecipitate of ferrous phosphate octahydrate and lithium phosphate containing lithium, iron, and phosphorus at a molar ratio of 0.9:0.9:1.

The composition of each solution was as described below.

Solution A1: divalent Fe atom 1 mol/L

Solution B1: Li atom 2 mol/L

Solution C1: P atom 1.5 mol/L

A lithium-iron-phosphorus compound oxide carbon complex was produced in a manner similar to that second step and third step in Example 1.

### Example 3

### First Step

### Preparation of Solution A

Solution A1 was prepared as in Example 1.

### Preparation of Solution B and Solution C

Solution B1 and Solution C1 were prepared in as Example 1.

The addition of Solution A and Solution B to Solution C

A reaction was conducted as in Example 1 except that the addition of solution was conducted while a nitrogen gas was injected into the reaction solution (Solution C).

After the dropping was completed, aging was conducted at a room temperature for 3 hours. Then, solid liquid separation was conducted by a common method, and drying was conducted at 50° C. for 10 hours so as to produce 60 g of precipitate.

The resulting coprecipitate was subjected to an XRD measurement and an ICP measurement. As a result, the resulting precipitate was a coprecipitate of ferrous phosphate octahydrate and lithium phosphate containing lithium, iron, and phosphorus at a molar ratio of 0.9:0.9:1.

The composition of each solution was as described below.

Solution A1: divalent Fe atom 1 mol/L

Solution B1: Li atom 2 mol/L

Solution C1: P atom 1.5 mol/L

A lithium-iron-phosphorus compound oxide carbon complex was produced in a manner similar to that second step and third step in Example 1.

### Comparative Example 1

Solution B2 was prepared by dissolving 18.9 g (0.45 mol, in terms of lithium atom 0.45 mol) of lithium hydroxide monohydrate into 131 ml of pure water.

On the other hand, Solution D1 was prepared by dissolving 9.7 g (0.075 mol, in terms of Li atom 0.15 mol) of lithium sulfate monohydrate, 39.7 g (0.15 mol, in terms of Fe atom 0.15 mol) of ferrous sulfate heptahydrate, and 19.6 g (0.15 mol. in terms of P atom 0.15 mol) of 75 percent by weight phosphoric acid into 231 ml of pure water.

Solution D1 was put into a reaction container. Solution B2 was dropped into the reaction container at a constant rate in such a way that the whole amount was dropped over 40 minutes while agitation was conducted at 70° C. After the dropping was completed, solid liquid separation was conducted by a common method, and drying was conducted at 50° C. for 7 hours so as to produce 27 g of precipitate.

The resulting precipitate was subjected to the ICP measurement. As a result, the resulting precipitate was a coprecipitate of ferrous phosphate octahydrate and lithium phosphate containing lithium, iron, and phosphorus at a molar ratio of 0.7:1:1.

The composition of each solution was as described below.

Solution B2: Li atom 3.4 mol/L

Solution D1: Li atom 0.5 mol/L, P atom 0.5 mol/L, divalent Fe atom 0.5 mol/L

### Second Step and Third Step

A lithium-iron-phosphorus compound oxide carbon complex was produced as in Example 1.

TABLE 1

First step

| | Composition of | | | |
|---|---|---|---|---|
| | coprecipitate | | | |
| | (molar ratio) | | | |
| | Li | Fe | P | Yield (%) |
| Example 1 | 0.8 | 0.9 | 1 | 97 |
| Example 2 | 0.9 | 0.9 | 1 | 97 |
| Example 3 | 0.9 | 1.0 | 1 | 98 |
| Comparative | 0.7 | 1.0 | 1 | 87 |
| example 1 | | | | |

1) The yield in Table 1 was determined as the percentage of the mass of actually obtained precipitate relative to the mass of precipitate to be obtained on a calculation basis. Evaluation of physical property of lithium-iron-phosphorus compound oxide carbon complex

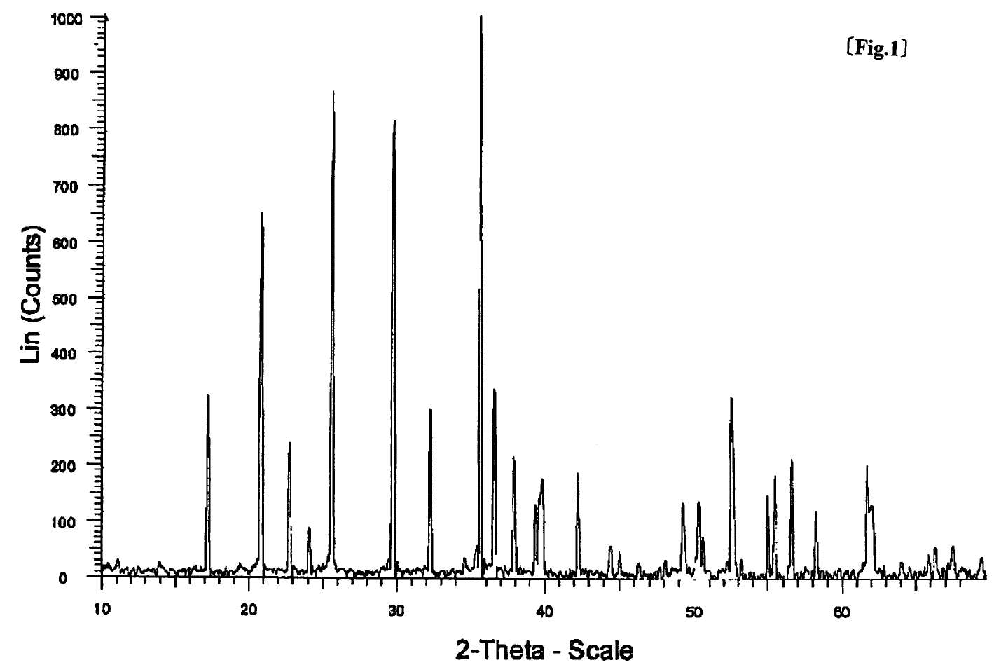

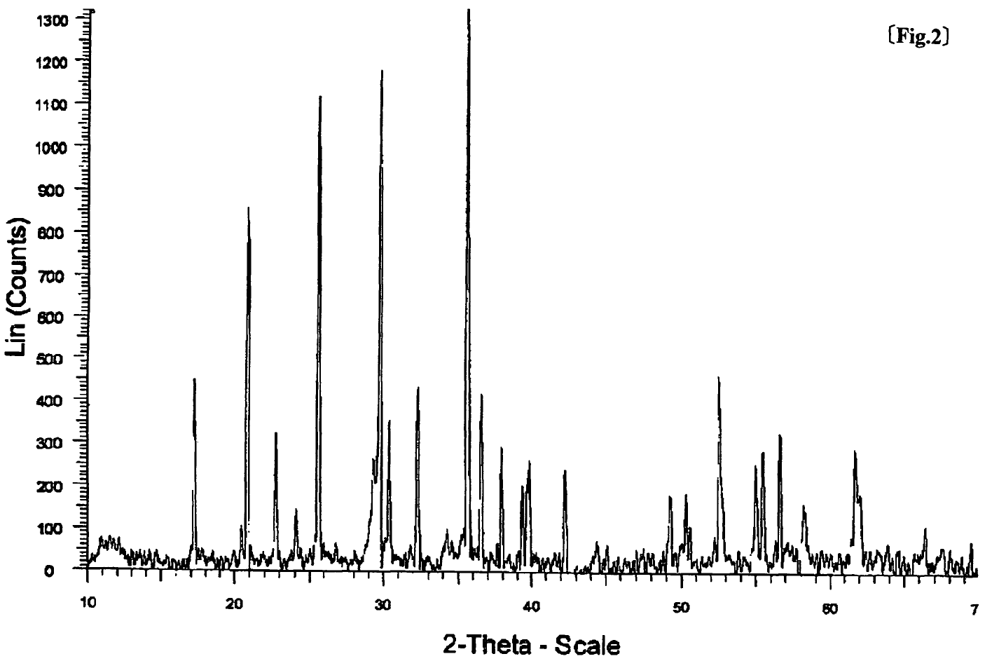

Regarding the lithium-iron-phosphorus compound oxide carbon complexes produced in Example 1 and Comparative example 1, the average particle diameters and the contents of electrically conductive carbon materials were measured and the X-ray diffraction analysis was conducted. The obtained results are shown in Table 2. The X-ray diffraction patterns of the lithium-iron-phosphorus compound oxide carbon complexes produced in Example 1 and Comparative example 1 are shown in FIG. 1 (Example 1) and FIG. 2 (Comparative example 1). The average particle diameter is an average value of particle diameters of 20 lithium-iron-phosphorus compound oxide particles arbitrarily extracted on the basis of the scanning electron microscope (SEM), that is, an average value of particle diameters of lithium-iron-phosphorus compound oxides themselves. The content of electrically conductive carbon material is a content of C atoms.

TABLE 2

| | Average | C atom content | Result of X- |
|---|---|---|---|
| | particle | (percent by | ray |
| | diameter (μm) | weight) | diffraction |
| Example 1 | 0.26 | 7.9 | LiFePO₄ single |
| | | | phase |
| Example 2 | 0.28 | 7.9 | LiFePO₄ single |
| | | | phase |
| Example 3 | 0.25 | 8.0 | LiFePO₄ single |
| | | | phase |
| Comparative | 0.32 | 6.3 | LiFePO4, |
| example 1 | | | Fe2P2O7 |

### Evaluation of Battery Performance

### Battery Performance Test

### (I) Preparation of Lithium Secondary Battery

A positive electrode agent was prepared by mixing 91 percent by mass of lithium-iron-phosphorus compound oxide carbon complex of Example 1 or Comparative example 1 produced as described above, 6 percent by mass of graphite powder, and 3 percent by mass of polyvinylidene fluoride. The resulting positive electrode agent was dispersed into N-methyl-2-pyrrolidinone so as to prepare a mixed paste. The resulting mixed paste was applied to aluminum foil. Thereafter, drying and pressing were conducted, so that a positive electrode plate in the shape of a disk having a diameter of 15 mm was stamped.

The resulting positive electrode plate and various members, e.g., a separator, a negative electrode, a positive electrode, a current collector, mounting brackets, external terminals, and an electrolytic solution, were used so as to produce a lithium secondary battery. Among them, as for the negative electrode, metal lithium foil was used, and as for the electrolytic solution, a solution in which 1 mol of LiPF₆ was dissolved in 1 liter of 1:1 mixed solution of ethylene carbonate and methyl ethyl carbonate was used.

### (II) Evaluation of Battery Performance

The resulting lithium secondary battery was actuated at room temperature, and the discharge capacity was measured. Furthermore, the ratio relative to the theoretical discharge capacity of LiFePO₄ (170 mAH/g) was calculated on the basis of the following formula (2). The results thereof are shown in Table 3.

ratio relative to theoretical discharge capacity={discharge capacity/theoretical discharge capacity of LiFePO₄ (170 mAH/g)}×100 (2)

TABLE 3

| | | Ratio relative to |
|---|---|---|
| | | theoretical |
| | Discharge capacity | discharge capacity |
| | (mAH/g) | (%) |
| Example 1 | 168 | 99 |
| Example 2 | 166 | 98 |
| Example 3 | 168 | 99 |
| Comparative | 122 | 72 |
| example 1 | | |

What is claimed is:

1. A method for manufacturing a lithium-iron-phosphorus compound oxide carbon complex, the method comprising the steps of:
adding a solution containing lithium ions (Solution B) to a solution containing phosphate ions (Solution C) while a solution containing divalent iron ions (Solution A) is added to Solution C so as to produce a coprecipitate containing lithium, iron, and phosphorus in a first step;
mixing the coprecipitate and an electrically conductive carbon material so as to produce a raw material mixture for calcining in a second step; and
calcining the raw material mixture for calcining in an inert gas atmosphere so as to produce the lithium-iron-phosphorus compound oxide carbon complex in a third step.

2. The method for manufacturing a lithium-iron-phosphorus compound oxide carbon complex according to claim 1, wherein the lithium source of Solution B is lithium hydroxide.

3. The method for manufacturing a lithium-iron-phosphorus compound oxide carbon complex according to claim 1 or claim 2, wherein the calcining temperature of the raw material mixture for calcining in the third step is 500° C. to 800° C.

4. A method for manufacturing a coprecipitate containing lithium, iron, and phosphorus, the method comprising the step of:
adding a solution containing lithium ions (Solution B) to a solution containing phosphate ions (Solution C) while a solution containing divalent iron ions (Solution A) is added to Solution C so as to produce a coprecipitate containing lithium, iron, and phosphorus in a first step.
